(19) United States
(12) Patent Application Publication
(10) Pub. No.: US 2008/0276473 A1
(43) Pub. Date: Nov. 13, 2008

(54) Method of projecting zero-convergence aiming beam on a target and zero-convergence laser aiming system

(76) Inventors: Michael Raschella, Montreal (CA); Marin Tanase, Montreal (CA)

Correspondence Address: RASCHELLA Michael, 116 MARIE-ANNE W., MONTREAL, QC, H2W 1B9, CA

(21) Appl. No.: 11/797,667

(22) Filed: May 7, 2007

(51) Int. Cl. F41G 1/00; G01C 15/00

(52) U.S. Cl. 33/286

(57) ABSTRACT

A method of projecting a zero-convergence aiming beam on a target and a zero-convergence laser aiming system are disclosed. The method comprises steps of sending a first linear beam from a first laser module on the target; sending a second linear beam from a second laser module on the target, the first and second linear beams being mutually oriented in a non-parallel manner to create on the target the aiming beam projection as an “X” intersection to ensure accurate and convenient shooting regardless of the distance to the target and the skill or experience of an operator. The laser aiming system is adjustably fixed to a tube and aligned with an axis line of said tube, and comprises a first laser module sending a first linear beam on the target; a second laser module sending a second linear beam on the target, the first and second linear beams being mutually oriented in a non-parallel manner.

### FIELD OF THE INVENTION

The present invention relates to aiming systems and more particularly to method of projecting a zero-convergence aiming beam on a target and a zero-convergence laser aiming system. The invention is mainly applicable to the field of disrupters but not limited to, for the explosive ordnance disposal industry in which the laser aiming systems are used to create one or more aiming beams. It may also be used as a range finder with the proper visual aids.

### BACKGROUND OF THE INVENTION

In the prior art, disrupters are used in various forms to neutralize a potentially explosive package so that the package does not detonate in its intended and harmful way. High speed water jets or other projectiles have been used to break apart the package.

The water acts in a way as to knock out the fuse, powers supply, etc. before the potential explosive can initiate and create a damaging impact.

In certain instances, a human, robot or unmanned device positions the disrupter in a desired location, and controls the displacement of the tube as well.

An aiming system is attached to a disrupter and projects a laser beam on the target. Currently, the aiming system is a laser system appearing at least one dot beam on the target where the water jet will hit.

While the use of now existing disrupters is effective in neutralizing a target package, the aiming operation of the disrupter is not without problems. In many instances the disrupter should be moved closer or further from the potentially explosive package and it is difficult to aim the barrel in a quick and exact manner at a given distance.

There are different devices directed to avoid these aiming problems and some of them are described below.

U.S. Pat. No. 5,118,186 issued to Schraetzenstaller J. et al. on Feb. 9, 1990, disclosed a method and apparatus for adjusting an aiming telescope and a laser range finder with a weapon system in which a reference reticle or an aiming graticule of the aiming telescope are aligned with the laser beam images in the collimator.

U.S. Patent Application Publication No. US20050278964 declared by Minica Stuart et al. published on Jun. 17, 2004 disclosed a laser targeting system projecting on the target laser spot where an arrow will hit once released.

Even as some of the above mentioned systems are practical, all of them suffer from the same principle defect related to a distance change, in that they need to be additionally calibrated during the disrupter's preparation at the scene. This is especially problematic when using a robotic platform since the distance that the robotic platform will be from the target when it arrives at the said target cannot be easily predicted from the operator's point of view. This specified defect makes them unusable for quick secured operations.

Accordingly, a need exists for improved techniques for aiming disrupter devices when neutralizing packages. The present invention solves this need by providing a method of projecting a zero-convergence aiming beam on a target and a zero-convergence laser aiming system which allows to easily, quickly and accurately aim the disrupter in a desired location.

We have developed a method of projecting a zero-convergence aiming beam on a target and a laser aiming system, integrating and incorporating diverse known and new technologies to deliver state of the art, practical and reliable aiming solutions, which makes this system much more versatile and effective than most.

The system can assist aiming of a disrupter, firearms, weapon system, etc. It is also adaptable to be customized to existing Laser Tag guns (Toy), Paintball guns and/or to be used as a new aiming system to better suit the user needs. It may also be used as an alignment instrument or range finder with the proper visual aids.

Thus, there is a need to develop a method of projecting a zero-convergence aiming beam on a target and a laser aiming system, which can be effectively pre-calibrated one time and out of dangerous zones or prior to usage and is effective in all conditions.

Still further features and advantages will become apparent from the ensuing description and drawings.

### OBJECTS OF THE INVENTION

Traditional laser sighting or aiming systems that are positioned at a certain distance away from the axis line (usually directly above or below the axis line) project a dot on the axis line at one given distance since the laser module is angled to do so. As soon as the laser module or system moves forward, the projected laser dot moves away from the axis line in the direction with respect to the location that the laser module is mounted and vice-versa if moved back. By doing so, alignment is lost and the laser module angle must be increased/decreased to correct and return the projected dot to the axis line. If the distance that the laser module moves is unknown, alignment is impossible without the use of another laser module exactly on the axis line (typically a bore laser) which will project a dot on the said axis line or by the use of trigonometry and or a range finder.

Accordingly, an object of the present invention is to provide an improved method of projecting a zero-convergence aiming beam on a target and a zero-convergence laser aiming system that obviates the above-mentioned disadvantages.

A principle object of the present invention is to provide a method of projecting a zero-convergence aiming beam on a target and a zero-convergence laser aiming system, which is always pointing at a tubes line of sight or axis line.

Next object of the present invention is to present a method of projecting a zero-convergence aiming beam on a target and a zero-convergence laser aiming system which is easily pre-calibrated one time and out of dangerous zones or prior to usage.

Another object of the present invention is to provide a method of projecting a zero-convergence aiming beam on a target and a zero-convergence laser aiming system which does not require adjustment in the dangerous zone or during use.

One more object of the present invention is to provide a method of projecting a zero-convergence aiming beam on a target and a zero-convergence laser aiming system having a self aligning cross hair.

Still another object of the present invention is to provide a method of projecting a zero-convergence aiming beam on a target and a zero-convergence laser aiming system that is adaptable for different style disrupters, firearms, weapon systems, laser Tags (Toys), Paintball guns, etc. . . .

A further object of the present invention is to provide a method of projecting a zero-convergence aiming beam on a target and a zero-convergence laser aiming system, which is compact in design.

Still another object of the present invention is to provide a method of projecting a zero-convergence aiming beam on a target and a zero-convergence laser aiming system, which is lightweight.

Other and further objects and advantages of the present invention will be obvious upon an understanding of the illustrative embodiments about to be described or will be indicated in the appended claims, and various advantages not referred to herein will occur to one skilled in the art upon employment of the invention in practice.

### SUMMARY OF THE INVENTION

The present invention provides a method of projecting a zero-convergence aiming beam on a target and a zero-convergence laser aiming system.

According to a first embodiment of the present invention, it is describing a method of projecting a zero-convergence aiming beam on a target by a zero-convergence laser aiming system having at least two laser modules. The laser modules are adjustably fixed to a tube and aligned with the axis line of said tube. The method comprises the steps of sending a first linear beam from a first laser module on the target; sending a second linear beam from a second laser module on the target. The first and second linear beams being mutually oriented in a non-parallel manner to create on the target the aiming beam projection as an “X” intersection to ensure accurate and convenient shooting, aiming or aligning regardless of the distance to the target and the skill or experience of an operator.

According to another aspect of the present invention, it is describing a method of projecting a zero-convergence aiming beam on a target by a zero-convergence laser aiming system having at least two laser modules. The laser modules are adjustably fixed to a tube and aligned with the axis line of said tube. The method comprises the steps of sending a first linear beam from a first laser module on the target, the first linear beam being oriented in the vertical proximity; sending a second linear beam from a second laser module on the target, the second linear beam is oriented in the horizontal proximity. The first and second linear beams are mutually oriented in right angled manner to create on the target the aiming beam projection as a cross-hair to ensure accurate and convenient shooting, aiming or aligning regardless of the distance to the target and the skill or experience of an operator.

A zero-convergence laser aiming system is adjustably fixed to a tube and aligned with the axis line of said tube. The system comprises a first laser module sending a first linear beam on the target and a second laser module sending a second linear beam on the target. The first and second linear beams are mutually oriented in a non-parallel manner to create on the target the aiming beam projection as an “X” intersection to ensure accurate and convenient shooting, aiming or aligning regardless of the distance to the target and the skill or experience of an operator;

The first and second linear beams could be mutually oriented in right angled manner to create on the target the aiming beam projection as a cross-hair to ensure accurate and convenient shooting, aiming or aligning regardless of the distance to the target and the skill or experience of an operator.

The invention accordingly comprises the furthers of construction, combination of elements, arrangement of parts of the method of projecting a zero-convergence aiming beam on a target and a zero-convergence laser aiming system, which will be exemplified in the construction hereinafter set forth, and the scope of the invention will be indicated in the claims.

### BRIEF DESCRIPTION OF THE DRAWINGS

For a fuller understanding of the nature and object of the invention, reference should be had to the following detailed description taken in connection with the accompanying drawings in which:

FIG. 1a illustrates a method of projecting a zero-convergence aiming beam on a target and a zero-convergence laser aiming system according to the present invention, in which the aiming beam is a non right angled “X” intersection;

FIG. 1b illustrates a front view of FIG. 1a;

FIG. 2a illustrates a method of projecting a zero-convergence aiming beam on a target and a zero-convergence laser aiming system according to the present invention, in which the aiming beam is a right angled cross-hair;

FIG. 2b illustrates a front view of FIG. 2a;

FIG. 2c illustrates a side view of FIG. 2a;

FIG. 2d illustrates a top view of FIG. 2a;

FIG. 3 illustrates a method of projecting a zero-convergence aiming beam on a target and a zero-convergence laser aiming system according to the present invention, in which the aiming beam is as cross-hair on a target located at a short-distance;

FIG. 4 illustrates a method of projecting a zero-convergence aiming beam on a target and a zero-convergence laser aiming system according to the present invention, in which the aiming beam is as cross-hair on a target located at a long-distance;

FIG. 5 illustrates an assembled view of the laser aiming system, according to the present invention; and

FIG. 6 illustrates one example of the unlimited position combinations that the zero-convergence aiming beam and zero-convergence laser aiming system can have in space, according to the present invention.

### DETAILED DESCRIPTION OF THE PREFERRED EMBODIMENTS

With reference to the annexed drawings, the preferred embodiments of the present invention will be herein described for indicative purposes and by no means as of limitation.

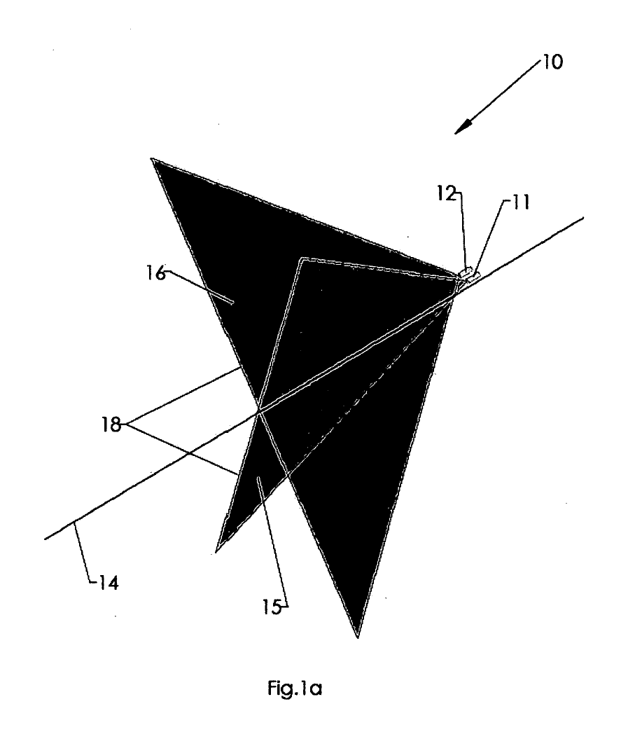

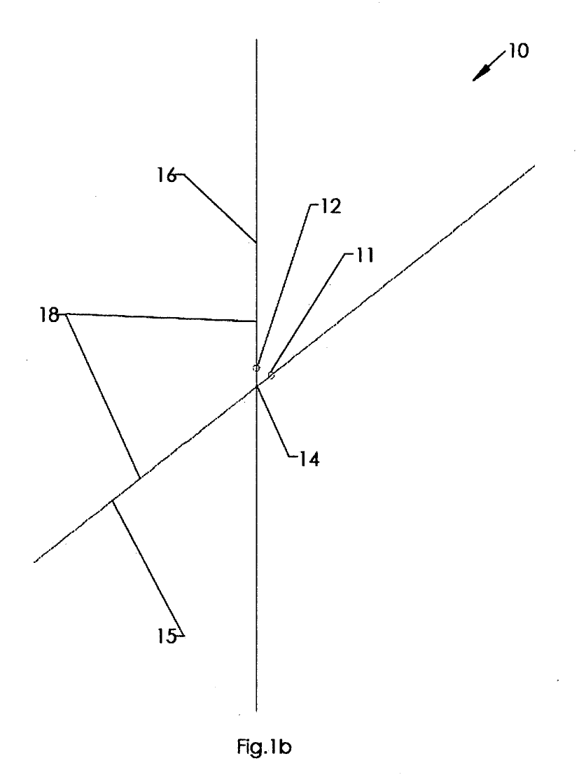

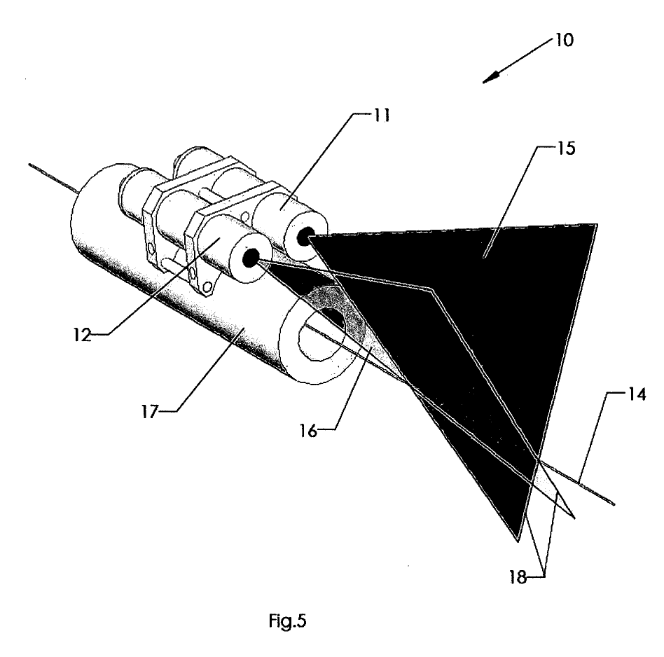

As best shown in FIGS. 1 through 6, the present invention relates to a method of projecting a zero-convergence aiming beam on a target, object, etc. . . . by a zero-convergence laser aiming system 10. The system 10 has at least two laser modules. FIGS. 1 to 6 show the system 10 which includes two laser modules 11 and 12 being adjustably fixed to a tube, barrel, Weaver® dovetail/Picatinny® rail mount or any other mount, firearm, weapon system, toy, Paintball gun, alignment tool, etc. . . . 17 (see FIG. 5) and aligned with the axis line 14 of said tube.

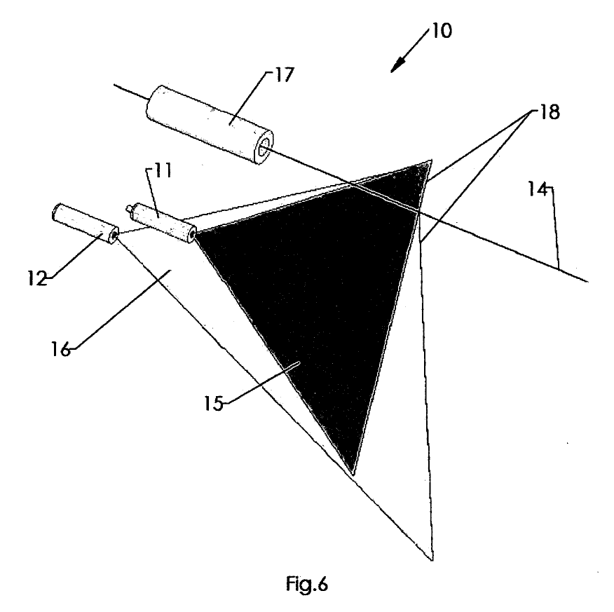

The axis line is not limited to the centroid of the said tube; the laser system can align itself to any imaginary or set axis line outside of the boundary of the tube or system it is attached to. In fact, the laser modules can be located at different positions in space with different laser fan angles to create the system 10 (see FIG. 6) or 10a as described below.

Referring to FIGS. 1a and 1b, a first embodiment of the method comprises the steps of sending a first linear beam 15 from a first laser module 11 on the target, object, etc. . . . ; sending a second linear beam 16 from a second laser module 12 on the target, object, etc. . . . The first 15 and second 16 linear beams are mutually oriented in a non-parallel manner. It allows to create on the target, object, etc. . . . the aiming beam projection 18 as an “X” intersection ensuring accurate and convenient shooting, aiming or aligning regardless of the distance to the target, object, etc. . . . and the skill or experience of an operator.

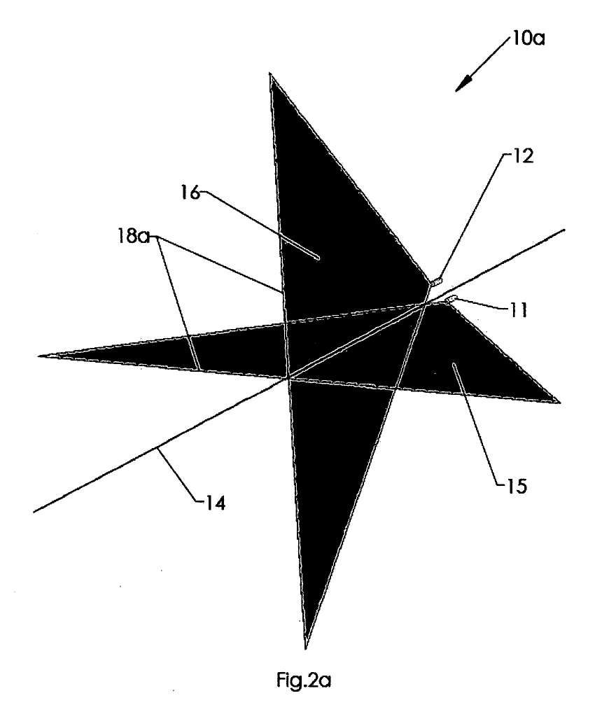

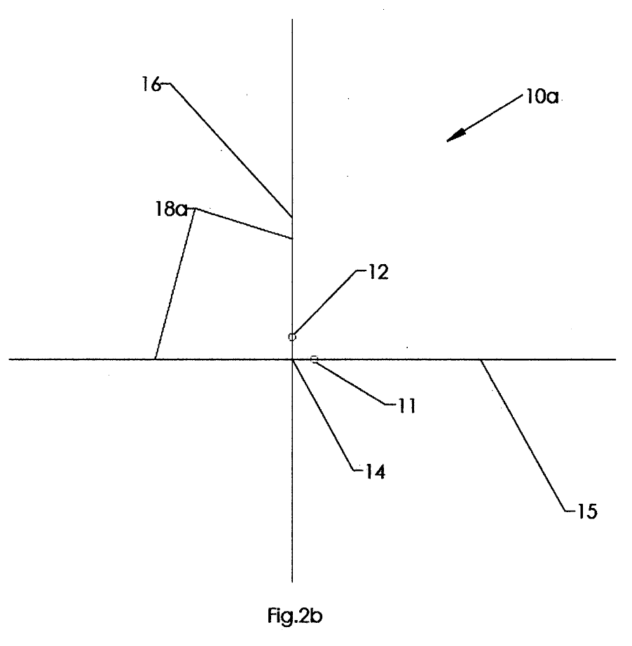

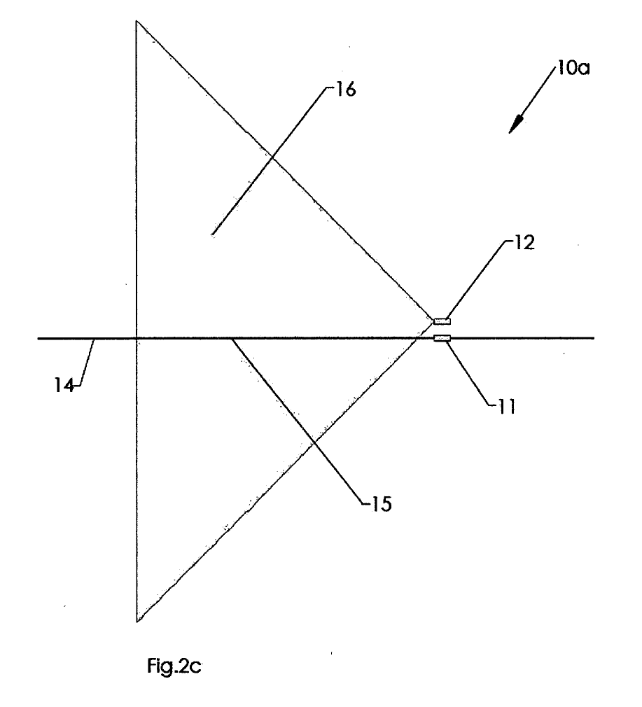

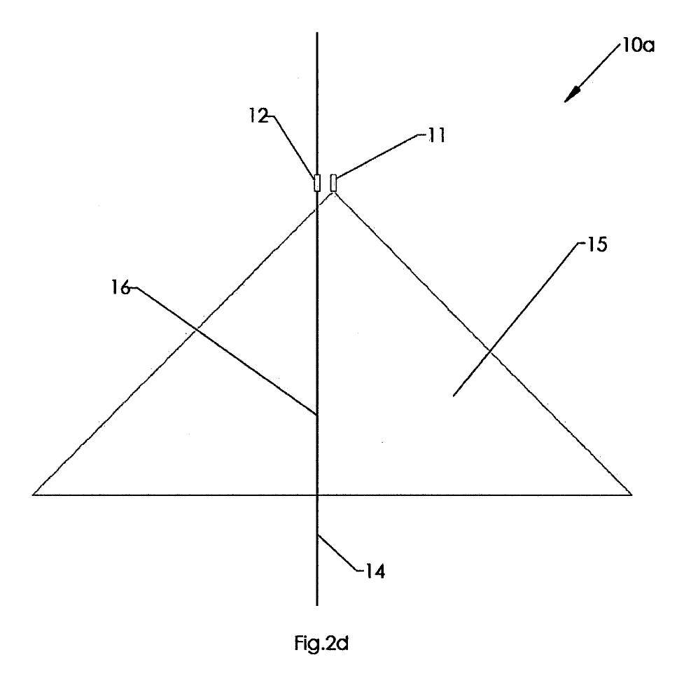

Referring to FIGS. 2a, 2b, 2c, 2d, 3 and 4, a second embodiment 10a of the method comprises the steps of sending a first linear beam 15 from a first laser module 11 on the target, object, etc. . . . ; sending a second linear beam 16 from a second laser module 12 on the target, object, etc. . . . The first 15 and second 16 linear beams are mutually oriented in a right angled manner to create on the target, object, etc. . . . the aiming beam projection as a cross-hair to ensure accurate and convenient shooting, aiming or aligning regardless of the distance to the target, object, etc. . . . and the skill or experience of an operator.

The zero-convergence laser aiming system 10 of the first embodiment is adjustably fixed, attached, etc. . . . to a tube 17 and aligned with the axis line 14 of said tube. The system 10 comprises a first laser module 11 sending a first linear beam 15 on the target, object, etc. . . . ; a second laser module 12 sending a second linear beam 16 on the target, object, etc. . . . The first and second linear beams 15 and 16 are mutually oriented in a non-parallel manner to create on the target, object, etc. . . . the aiming beam projection 18 as an “X” intersection to ensure accurate and convenient shooting, aiming or aligning regardless of the distance to the target, object, etc. . . . and the skill or experience of an operator.

The zero-convergence laser aiming system 10a of the second embodiment is adjustably fixed, attached, etc. . . . to a tube 17 and aligned with the axis line 14 of said tube. The system 10a comprises a first laser module 11 sending a first linear beam 15 on the target, object, etc. . . . ; a second laser module 12 sending a second linear beam 16 on the target, object, etc. . . . The first 15 and second 16 linear beams are mutually oriented in a right angled manner to create on the target, object, etc. . . . the aiming beam projection as a cross-hair 18a to ensure accurate and convenient shooting, aiming or aligning regardless of the distance to the target, object, etc. . . . and the skill or experience of an operator.

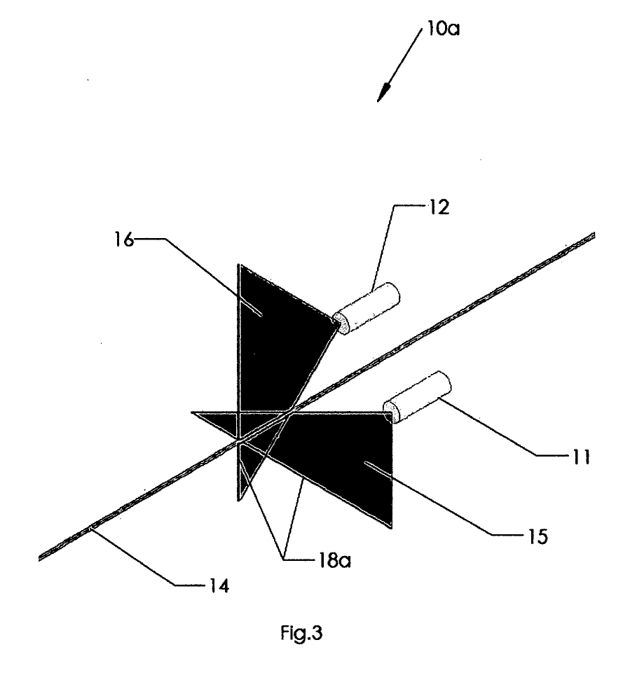

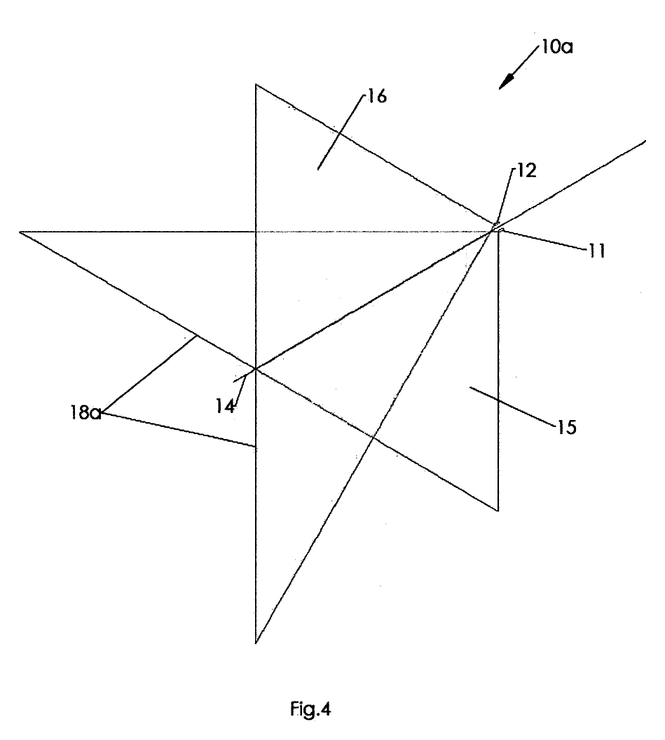

The zero-convergence laser aiming system 10 or 10a would be easily adjusted for user specific needs. Our laser aiming system 10 or 10a does need to be calibrated once attached to the tube 17. Even if the laser aiming system 10 or 10a is removed and then reattached to the tube 17 it does not need to be recalibrated. It creates on the target, object, etc. . . . an “X” intersection 18 or cross-hair 18a which is always intersecting at the axis line 14 of the tube 17 even if the distance to the target, object, etc. . . . changes (shown on FIGS. 3 and 4).

It is in contrast to now existing aiming systems where it is difficult to aim the barrel of a disrupter, Firearm, toy, Paintball Gun, etc. . . . in a quick and exact manner at a given distance when the disrupter, Firearm, toy, Paintball Gun, etc. . . . is moved closer or further from a potentially explosive package, target, object, etc. . . .

The aiming system according to the present invention may also be used as a range finder with the proper visual aids. Since the aiming beam projected changes in length depending on the distance (Shown on FIGS. 3 and 4) from a target, object, etc. . . . it can be measured with the aid of a measuring tool similar to a transparent ruler from the relative location of the aiming system. The above mentioned aiming system may be attached to the tube 17 in various ways but not limited to the following examples: for instance it could be attached to the tube by a Velcro strap, magnets, self adjusting clamps, screws, rings, or any other adjustable means, etc. . . .

Referring to FIG. 5 which is showing an example of the zero-convergence aiming system 10 (or 10a with changes made to the attachment configuration), the laser modules 11 and 12, tube 17, axis line 14, linear beams 15 and 16, “X” intersection 18 (or 18a with changes made to the attachment configuration) for a better understanding.

The system 10 or 10a can be factory calibrated to fit on a diverse style of disrupters (or firearms, weapon systems, toys, Paintball guns, alignment tool, etc.) without future adjustments to disarm or render a “suspicious package” safe (or aim, align, etc. . . . ) The system 10 or 10a can also be field calibrated to fit on a diverse style of disrupters or any other type of tube, barrel, firearm, weapon system, toy, Paintball gun, alignment tool, etc. . . . 17 without future adjustments to disarm or render a “suspicious package” safe (or aim, align, etc. . . . ). It always points or intersects at the tubes line of sight or axis line. When necessary, our system can be easily pre-calibrated one time and out of dangerous zones or prior to usage.

The system is attachable on the outside of the tube, barrel, firearm, weapon system, toy, Paintball gun, alignment tool, etc. . . . and does not interfere/restrict with the axis line of the tube or any projectile, beam, etc. . . . coming out of the said tube, etc. . . .

Our advanced system is designed to create an exact identification of the tube's line of sight or axis line on the target, object, etc. . . . at any distance without the need to recalibrate with a change of distance.

The aiming system according to the present invention can also host a number of special applications to take advantage of its unique capabilities.

The drawings and the description attached to it are only intended to illustrate the idea of the invention. As to the details, the invention may vary within the scope of the claims. So, the shape, size or other parameters of the method of projecting a zero-convergence aiming beam on a target, object, etc. . . . by a zero-convergence laser aiming system may be formed as desired, considering the needs and specifics of users' needs.

Although the present methods of projecting a zero-convergence aiming beam on a target, object, etc. . . . by a zero-convergence laser aiming system have been described with a certain degree of particularity it is to be understood that the disclosure has been made by way of example only and that the present invention is not limited to the features of the embodiment(s) described and illustrated herein, but includes all variations and modifications within the scope and spirit of the invention as hereinafter claimed.

What is claimed is:

1. A method of projecting a zero-convergence aiming beam on a target, object, etc. . . . by a zero-convergence laser aiming system having at least two laser modules, said laser modules being adjustably fixed to a tube or system and aligned with an axis line of said tube, system or any imaginary or set axis line outside of the boundary of said tube or system, said method comprising the steps of:
sending a first linear beam from a first laser module on the target, object, etc. . . . ;
sending a second linear beam from a second laser module on the target, object, etc. . . . , said first and second linear beams being mutually oriented in a non-parallel manner to create on the target, object, etc. . . . the aiming beam projection as an “X” intersection to ensure accurate and convenient shooting, aiming or aligning regardless of the distance to the target, object, etc. . . . and the skill or experience of an operator.

2. A method of projecting a zero-convergence aiming beam on a target, object, etc. . . . by a zero-convergence laser aiming system having at least two laser modules, said laser modules being adjustably fixed to a tube or system and aligned with an axis line of said tube, system or any imaginary or set axis line outside of the boundary of said tube or system said method comprising the steps of:
sending a first linear beam from a first laser module on the target, object, etc. . . . , the first linear beam being oriented in the vertical proximity;
sending a second linear beam from a second laser module on the target, object, etc. . . . , the second linear beam being oriented in the horizontal proximity, said first and second linear beams being mutually oriented in right angled manner to create on the target, object, etc. . . . the aiming beam projection as a cross-hair to ensure accurate and convenient shooting, aiming or aligning regardless of the distance to the target, object, etc. . . . and the skill or experience of an operator.

3. A zero-convergence laser aiming system being adjustably fixed to a tube or system and aligned with an axis line of said tube, system or any imaginary or set axis line outside of the boundary of said tube or system said system comprising:
a first laser module sending a first linear beam on the target, object, etc. . . . ;
a second laser module sending a second linear beam on the target, object, etc. . . . , said first and second linear beams being mutually oriented in a non-parallel manner to create on the target, object, etc. . . . the aiming beam projection as an “X” intersection to ensure accurate and convenient shooting, aiming or aligning regardless of the distance to the target, object, etc. . . . and the skill or experience of an operator;

4. A zero-convergence laser aiming system according to claim 3, wherein the first and second linear beams being mutually oriented in a right angled manner to create on the target, object, etc. . . . the aiming beam projection as a cross-hair to ensure accurate and convenient shooting, aiming or aligning regardless of the distance to the target, object, etc. . . . and the skill or experience of an operator.
